(19) United States
(12) Patent Application Publication
(10) Pub. No.: US 2012/0259482 A1
(43) Pub. Date: Oct. 11, 2012

(54) STORAGE SYSTEMS COMPRISING TRACTORS AND TRAILERS

(76) Inventor: Klaus Jeschke, Kelkheim (DE)

(21) Appl. No.: 13/508,336

(22) PCT Filed: Nov. 12, 2010
(86) PCT No.: PCT/EP2010/067346

§ 371 Date: Jun. 21, 2012

(30) Foreign Application Priority Data
Nov. 13, 2009 (EP) 09175935.7

(51) Int. Cl. B65G 1/00; G06F 17/00

(52) U.S. Cl. 701/2; 414/800

(57) ABSTRACT

Contrary to many storage systems in which the stored material is parked along rails and physical guides the instant invention includes self propelled tractors to move storage material arranged on trailers on a flat freely drivable storage surface to a desired position and parking it thereon. The slightly increased number of tractors which simultaneously perform storage and retrieval provide a high transfer speed.

### I. FIELD OF THE INVENTION

The invention relates to a storage system in which products are stored in a random manner and whose storage positions are only known to a central computer.

### II. BACKGROUND OF THE INVENTION

Storage systems of this type are known in many embodiments.

A very common embodiment is so-called high rack storage in which storage racks are set up on both sides of an alley in which a rack serving device (RGB) is moved horizontally and vertically, wherein the products are placed and stored on uniform trays or pallets and wherein the RGB is configured to store and retrieve the pallets.

On the one hand side the dimensions of the particular storage space are predetermined. On the other hand side, the storage rack often only has one storage position in its depth since a greater depth is only useful when e.g. identical products are stored in the same row behind one another, since the RGB can only engage the foremost tray or pallet of a row.

Due to the central control system, the most expensive mechanical component of high rack storage of this type is the RGB. Therefore and in order to avoid collisions, only one RGB is provided in a high rack storage per alley so that the storage and retrieval time for the products cannot fall below a minimum that is defined by the system.

Besides that, surface storages are known e.g. in pharmacies which can also be configured as high rack storages in which the products are stored in particular directly, thus not resting on trays or pallets and are placed on a storage surface that has as few physical dividers as possible and which are arranged in discrete levels above one another to the left and to the right of an alley for a rack serving device and which are directly engaged by the RGB which e.g. includes a gripper arm and which can be stored or retrieved from the storage surface.

Also here the parameter determining the storage- and retrieval time is the RGB which in turn besides the central control is the most expensive mechanical component. Therefore one alley of the storage in turn only includes one or two RGBs.

### III. DETAILED DESCRIPTION OF THE INVENTION

### a) Technical Object

Thus, it is an object of the invention to provide a method and a device for storing products in which in spite of rather small cost, the transfer rate can be easily adapted to respective requirements as well as the storage size while providing a high level of fail safety and redundancy of all elements.

### b) Solution

The object is achieved through the features of claims 1 and 8. Advantageous embodiments can be derived from the dependent claims.

It is the basic principle of the storage method according to the invention that products are standing or lying on trailers and that the trailers which are loaded with one or plural identical or different products are stored on a storage surface at storage positions that are not physically divided and which are determined and predetermined by a central control for each storage event. Insofar this is a random storage system since the actual storage position of a particular product is only known to the central control.

The trailers which do not have a drive themselves are moved through tractors which have a drive themselves on the storage surface to a storage location and from the storage location, e.g. from a loading station at which an empty trailer is loaded with one or more products to a storage location or vice versa from a storage location to an unloading location where the product is retrieved from the trailer again and possibly further to a holding position for empty trailers which, however, is outside of the actual storage location.

Since the tractors can pull and also push they can also be designated as “rack serving devices” in this application in a more general manner and the trailers can also be designated as “trays” or “containers” which, however, would render visualization more difficult.

The storage location shall thus be physically divided as little as possible, thus in an ideal case it shall be a horizontal flat surface with maximum size. Certainly the storage surface can also be distributed over several levels above one another which then requires moving the loaded trailer possibly also together with the tractor from one level into another, e.g. through an elevator. By the same token, particular areas, e.g. a cooling area, can be separated and only be approached by the tractors through a lock.

In case there are several levels the vertical distance between the particular levels is only sized as required for the largest, thus tallest products to be stored, thus it is typically lower than required for a human operator to walk through.

The tractors and in particular the trailers have to be flat accordingly and in particular the tractors have to be configured to operate on the storage surface completely autonomously.

This means that the tractors certainly as a function of commands received from the central control which they receive wirelessly approach an empty or loaded trailer, hook it up, move it on a movement path or movement area predetermined by the central control based on the known current storage map, park it in the storage position independently, and then move it e.g. to a parking position for tractors where they can reload their respective energy storage devices.

The advantage of the storage system is that the cost of the tractors used is much less than the cost of a rack serving device that is movable in elevation and therefore the storage times can be quickly reduced by using a number of relatively large tractors as a function of the size of the storage surface. Also providing the storage surface itself is done in a very cost effective manner since no specific installations like precisely fitting rails, rail connections, switches, power supplies, etc. are required and only a stable flat storage surface has to be provided.

These advantages outweigh the intrinsic disadvantages of the system by far, namely that a very large number of trailers is required on which the products remain during storing. The trailers can be manufactured in a very effective manner since they have no drive and can be reduced to a minimum, ideally a base plate, possibly with a non-sliding mat and/or recesses or compartments for placing/inserting the products at whose bottom side there are e.g. two or more sliding surfaces through which the trailer is pushed or pulled in a sliding manner over the loading surface. Thus, also plural types of trailers can be used in the same storage facility, e.g. trailers with different sizes with or without subdivision into plural storage recesses or into storage recesses with different sizes.

Even turning wheels are not necessarily required at the trailers.

The trailer, however, can also include laterally protruding sidewalls in order to prevent products from hanging over easily or falling out.

The required coupling between trailer and tractor which also has to work automatically is thus configured so that the expensive coupling element is arranged at the tractor and the coupling element at the trailer is rather low value in order to, for example, only include holes in the sidewall that have a defined size and that are arranged in a defined manner in which respective coupling elements of the tractor can engage.

The coupling elements should preferably not only be provided at one face of the trailer but at least at two faces that are opposite from one another in order to keep the number of switching movements as small as possible.

Coupling a tractor to a trailer preferably causes a slight rising of the trailer on the side of the engaged coupling in order to lift the trailer from the ground at this side, thus from the storage surface which makes the behavior of a train including a trailer and a tractor predictable during pulling and pushing operations.

In another embodiment the trailers include at least three, better four sliding surfaces at their bottom sides, wherein the sliding surfaces are in permanent contact with the storage surface, thus also in hooked up condition so that they are not lifted up during coupling. Thus, the number of the sliding surfaces that are in contact is not reduced during movement through a tractor; however, the coupling can be implemented in a simpler manner since it does not have to cause any lifting of the trailer.

Thus also no particular side of the trailer is preferred for coupling so that coupling can be performed from all sides which reduces switching.

Ideally, the trailers in this case have a square planform as long as this is not disadvantageous as a matter of principle due to the size of the products to be stored and they include couplings on all sides.

In order to perform their tasks, the tractors include an emergency channel for transmitting signals besides a transmitter and a receiver for wireless reception of signals from and to the central control which is provided in particular via WLAN, which emergency transmitter can operate in particular via radio or ultrasound in case the normal signal transmission channel fails or does not function at particular locations of the storage surface and the tractors include a particular tractor control which performs implementing driving jobs and which is typically distributed over plural processors. Additionally the tractors include at least one camera that is pivotable e.g. with respect to the viewing direction and/or a separate camera for forward, backward and/or lateral directions. These cameras on the one hand side have to be configured to identify and process the bar codes which are arranged at the trailers and should additionally include an image processing unit which is included in the tractor control in order to be able to automatically determine a lateral offset and/or distance from the trailer to be coupled at least during coupling, but also in other cases. Additionally, the cameras can certainly also be used as orientation aids for an operator standing outside the storage and manually driving the tractor.

Alternatively and/or additionally the tractors can support at least one laser which projects a line of light onto the ground and/or the ceiling there above and/or a trailer to be coupled and which detects through a computation method like e.g. a light intersection triangulation method where a corner of the trailer is disposed and whether a lateral and angular offset from the tractor to be coupled is provided.

Furthermore, each tractor includes distance sensors on the backside and/or the front side and on the sides in order to detect imminent collisions in forward direction while driving forward and also while driving backward without a trailer, and furthermore during driving backward for the purpose of coupling to determine the distance and an angular offset to the trailer which is possible in that two distance sensors offset in transversal direction are provided on the rear side.

In case the tractor fails to automatically implement a drive command obtained from the central control, no matter whether the trailer to be coupled has changed its position unexpectedly, driving in the predetermined direction is not possible due to a sagging base plate or similar, thus as an emergency measure always initially manual operation of the tractor and as another measure using a rescue tractor which in turn can be driven in an automatic or manual mode can be resorted to.

The communication options of the tractor also include the option that two tractors communicate directly with one another, thus not only through the central control, e.g. to jointly achieve an object e.g. like a first tractor hooks up a trailer that is standing in the way and moves it aside so that a second tractor can pick up a trailer standing behind the first trailer.

Preferably the tractors will all be configured the same, however, depending on the structure of the storage also different tractors, e.g. tractors with different sizes and different power ratings can be used.

For each particular trip of each tractor the central computer does not only predetermine start- and destination position for the movement path but also at least the available movement range, better the movement path which is determined by the central computer in view of the current storage map, thus at which locations the storage area is occupied with loaded or unloaded trailers or idling tractors. Additionally certainly also the points in time, thus the starting points are determined, optionally the movement velocity and thus also the timing of the movement path is precisely predetermined by the central computer since only this way collisions can be avoided for many tractors that are in use simultaneously.

In a practical application this could be done in a way that the central computer does not only predetermine a start point and a destination for a driving job to the tractor control, but on the one hand side predetermines the areas that are scheduled for driving, thus including the storage map about these cleared surfaces, in particular the entire storage map and time zones in which the tractor or the train can use the particular portions of the cleared areas, thus the respectively cleared partial portions.

The tractor control always reports the current position to the central computer, at least, however, passing over particular preferred points like e.g. intersection- or the boundaries between particular cleared partial portions.

Within the areas that are cleared for driving, the tractor computer, however, preferably selects the exact route itself, for example based on efficiency considerations like shortest drive path or lowest number of turns to be passed slowly or similar and it also determines its velocity itself.

When handing over the data for the storage map, the central computer computes a so-called increased tolerance zone about each obstacle, wherein the tolerance zone is used for increasing collision safety and whose size can also be increased or reduced as a function of the events in the storage and as a function of the collisions that have actually or almost occurred, not only for the entire storage, but also for particular storage portions or even particular obstacles.

Passing through the particular cleared partial portions can be not only scheduled as a function of particular time limits by the central computer but also as a function of other events occurring, like e.g. another tractor or train crossing before the tractor to be controlled moves on.

In order for the tractors to be able to run a predetermined path and in order to pick up or drop trailers off at predetermined positions, different types of navigation systems can be provided for the tractors.

According to the invention, an optical orientation system for the tractors on the storage surface or the ceiling surface there above is preferred, in that optical markers are arranged therein, wherein the tractors use the optical markers for orientation through optical sensors provided at the tractors.

Thus, a preferred type of optical markers are bar codes in bar shape or two dimensional shape which are on the top side of the storage area in many configurations, in particular in a periodic configuration on the top side of the storage surface or the bottom side of the ceilings. In a preferred embodiment, the entire surface is imprinted with small bar codes essentially covering the entire surface, wherein the tractors get their orientations from the bar codes.

However, optical markers or patterns can also be used that are distributed in a random manner on the floor and ceiling surfaces, e.g. for particle boards provided as floor and/or ceiling boards the relatively few dark chips provided in their surface which dark chips contrast over the remaining light colored chips, or particularly long chips in particular whose orientation and/or length is above a certain threshold value.

These e.g. dark chips provided as a pattern can be automatically detected with respect to their positions and their exact centers can be automatically computed and used for markers.

Thus, the position of all markings can be read and stored in a first teaching run, particular markers or groups of markers including a relative position of the markers within a group relative to one another, and during later navigation these e.g. unambiguous groups can be recognized and navigation can be performed based on their known positions.

However, also a combination of optical markers like e.g. bar codes with a continuous line pattern applied in one or two intersecting spatial directions is feasible. The bar codes can then either be arranged within each grid field at a predetermined position, respectively e.g. filling the surface or in the same corner or they can also be arranged in the intersection portion of the grid lines that has been kept clear or similar.

The guidelines of such one or two dimensional pattern would simplify defining the movement direction of the tractors.

In order to keep the requirement for clear spaces on the storage surface for movement paths and switching operations as small as possible, it is essential that the tractors are as maneuverable as possible, thus in particular have a turning radius that is as small as possible, preferably so that they have a zero turn radius and certainly can move in all directions.

In a preferred embodiment, the tractors preferably only have three wheels arranged in a triangle, preferably in a triangle with identical sides or they have four wheels drivable independently from one another that are arranged in a rectangle, wherein the geometric rotation axes of the wheels intersect e.g. in a single point and are arranged e.g. at corners of a tractor that is also triangular in top view.

Through specifically controlling the particular wheels, each desired movement direction and also turning on a spot can be implemented when the wheels viewed in top view e.g. are tangents of a circle running through all three wheels.

In order to avoid strong wear at the wheels which are in this case often moved at a slant angle to their rolling direction or even perpendicular thereto, wheels are being used with transversal sliding rollers integrated into their running surfaces, wherein the transversal sliding rollers preferably have a convex contour as it is already known in principle from the rolling tracks of conveyor systems.

Depending on the mechanical complexity and the cost of the coupling at the tractor, the tractor can have a coupling of this type only at a face or at each of its faces, wherein the latter increases complexity but reduces switching times.

Since it cannot be excluded for a storage system of this type that control errors, a product falling off a trailer, a trailer tipping over, gaps or bumps in the storage surface or similar make it impossible for a tractor to implement the commands predetermined by the central control or due to a technical defect in the tractor the tractors simply breaks down, the obtained commands are implemented incorrectly or not implemented at all but are simply not being executed, practical rescue measures form an essential element of the method according to the invention. This is also done in view of the fact that typically the storage surface will be in several levels above one another and the distance there between is too small for a human operator to even crawl in there in order to manually remove collisions, contaminations or similar that occur in one level.

A possible error is e.g. contamination of the storage surface through a spilled powdery or liquid storage product or similar which would prevent the markers on the storage surface from being read by an optical sensor of the tractor. For this purpose there are either special cleaning tractors and/or cleaning trailers which are configured with special cleaning devices in order to remove solid or liquid contamination from the storage surface as a function of the types of products stored.

Another interference to be expected is a tractor that has broken down or implements received signals in a completely wrong manner.

Though the tractors have to be controlled by the central control, each tractor preferably has to be provided with one or better plural on board processors of their own which is not only capable of transforming the signals received by the central control but also capable of reacting individually itself in an emergency based on the information obtained from its own sensory equipment thus to compute a detailed travel path within the coarse travel path predetermined by the central control or to compute an alternative route e.g. within the portions cleared by the central computer, e.g. based on sensors additionally provided at the tractor which scan the environment, e.g. cameras or ultrasound sensors.

This at least one onboard processor also has to be configured to determine malfunctions of the tractor and in this case to shut down the tractor as an emergency measure.

For this purpose, the particular jobs are partially distributed to particular processors, wherein one processor is preferably used as a so-called watchdog which shall recognize the crashes of the main processor in the tractor and which when in doubt brings the processor into the starting position through reset.

On the other hand, the main processor recognizes malfunctions of its subordinate processors based on contradictions from the reports of the subordinate processors and optionally from information from directly connected sensors, processed camera images and/or information from the central computer.

A shutdown or broken down tractor is then removed from another tractor, the rescue tractor from the storage surface, so that it can be repaired.

This can also be performed through coupling the rescue tractor to the crashed tractor through the normal coupling which consequently has to be configured so that there are no male or female or positive and negative coupling elements or the tractors have a special rescue eyelet or rescue coupling at which a rescue tractor can be coupled.

Each tractor has to be configured with respect to its pull force to also pull a fully loaded trailer. However, if the weight of the tractor is higher than the weight of a fully loaded trailer, a rescue tractor furthermore has to be capable of pulling another tractor also when a loaded trailer is attached to the tractor which cannot be decoupled since the coupling does not work. In particular a rescue tractor of this type, optionally also all tractors can have a plug-in socket for emergencies for plugging in a long signal cable in order to provide a reliable functioning communication link from a manual control of an operator or the central control with a rescue tractor of this type through a cable run out of the storage surface.

By the same token, a rescue tractor can have an eyelet for attaching a rescue cable through which a rescue tractor together with a crashed tractor, a coupled jammed trailer or for any reasons whatsoever can be pulled from the storage surface mechanically through the pull cable and thus with a stronger pull force than can be applied by a tractor.

Preferably in the storage method according to the invention, also loading and unloading the trailers is automated.

Thus, it is irrelevant whether the loading and unloading stations mechanically are robots with grippers or suction cups, pivoting devices or other solutions, however it is clear that a central control then certainly also has to control these loading- and unloading stations and also an elevator or another transfer device from one level of the storage surface to another level.

The storage surface itself includes a surface that is as flat as possible on which the tractors with the trailers can move as freely as possible unimpeded by obstacles like struts or similar.

Whether the drop off especially of loaded trailers in storage positions is performed so that each trailer is surrounded by sufficient movement paths in order to be able to be coupled and hauled away immediately or whether a self blocking storage positioning is selected in which trailers standing in front thereof have to be removed first in order to reach a trailer standing behind them depends on various factors like size and arrangement of the storage surface, frequency of product switching, size of the products and trailers, etc. and has to be decided case by case.

Typically the storage surface will not be arranged in one plane but in several levels above one another so that the particular levels of the storage surface have to be built in particular levels of the storage surface through struts and/or trusses above one another in a stable manner which, depending on the size of the storage surface, requires struts at particular distances in the storage surfaces respectively arranged thereunder.

In a preferred embodiment, the struts are arranged in a grid through all levels at the same position continuously above one another, wherein the storage surface includes particular rectangular base plates which are arranged in a grid pattern, so that under each corner point where four of these base plates join one another, a strut is arranged thereunder on which all four corners of the four base plates are supported. Optionally the edges of the base plates joining one another are additionally supported by a truss.

Preferably the base plates rest on struts and trusses, however only in a loose manner and are attached so that they can be disassembled easily.

In case a base plate or the hole created after moving the base plate is large enough so that a human operator can climb through, the method for an operator to enter the interior of a multi-floor storage of this type is that e.g. starting at the uppermost level, a base plate (optionally also adjacent base plates) are removed from the created hole, the base plate arranged directly thereunder is disengaged, placed vertically and diagonally retrieved in upward direction through the hole disposed there above and this is done over several levels in downward direction until the operator has reached the desired level at which he has to manually perform repairs or other functions. The same can also be done from the bottom side.

The storage surface or the particular base plates preferably have a layer configuration which corresponds to a typical floor laminate, thus
a lower layer e.g. made from wood providing load bearing capability which in turn can include plural particular layers,
at whose top side an imprint or coating is arranged with a predetermined optical structure which among other things also includes the markings, in particular optical markings, and
there above a transparent layer from abrasion resistant material, in particular plastic material on which the trailers and tractors run.

Since base plates of this type can be produced in a very cost effective manner with existing machines for laminate floor coverings, the entire storage surface can be produced with little expense.

The tractors furthermore have their own energy supply, preferably an electrical energy storage device configured as an accumulator which can be automatically recharged at predetermined idle positions for the tractors through a recharge station arranged at this location. Recharge stations of this type can also be provided at loading- and unloading stations.

The automatic or manual loading and unloading stations are preferably arranged at an outer edge of the storage surface, in a multi-level storage surface loading and unloading positions can also be at different levels, for example in order to use gravity during an unloading process in that the unloading station only operates through pivoting out a trailer and the product tipped off there from slides to a conveyor belt arranged at a lower level, e.g. through slanted slides.

On the other hand side, a loading station should be configured to place the product in a precisely defined position on the trailer which is on the one hand side necessary for reasons of easier detectability through sensors of subsequent stations, on the other hand side also for reasons of utilizing the space on the placement surface of the trainer when more than one product shall be placed thereon.

With respect to coupling the tractors to the trailers, but also to other tractors there are two options in principle.

The first option is to only have a single connection point at the two vehicles to be connected and about this connection point, which e.g. can be the front end of a towing bar which is arranged at the trailer, a rotation of the two vehicles relative to one another is feasible about a vertical axis.

This rotatability reduces the space requirement for switching, however makes the switching process substantially much more difficult.

Another option for coupling two units is to couple them torque proof that means as a rigid unit in top view which is facilitated best by two coupling devices offset in transversal direction adjacent to one another and which snap lock into one another. The behavior during switching like e.g. maneuvering a tractor with a trailer into a parking spot backward can be calculated in an easier manner in this case and can be implemented in an easier manner through an automatic control.

Through the tractors, starting from a standstill in all directions it is also possible then to keep the space requirements for switching approximately as small as for the first alternative of a rotatable coupling.

Besides the described tractors for coupling the described trailers, there can also be lifting tractors in the same storage which are capable of gripping products placed on the storage surface directly through a gripper, thus without a trailer and to support the products at the lifting tractor during transportation. This facilitates storing products on the storage surface without trailer which, however, is only useful for products which compared to the weight of the tractor are rather light, in particular significantly lighter than the tractor itself.

### c) Embodiments

Embodiments of the invention are subsequently described in an exemplary manner with reference to the drawing figure wherein:

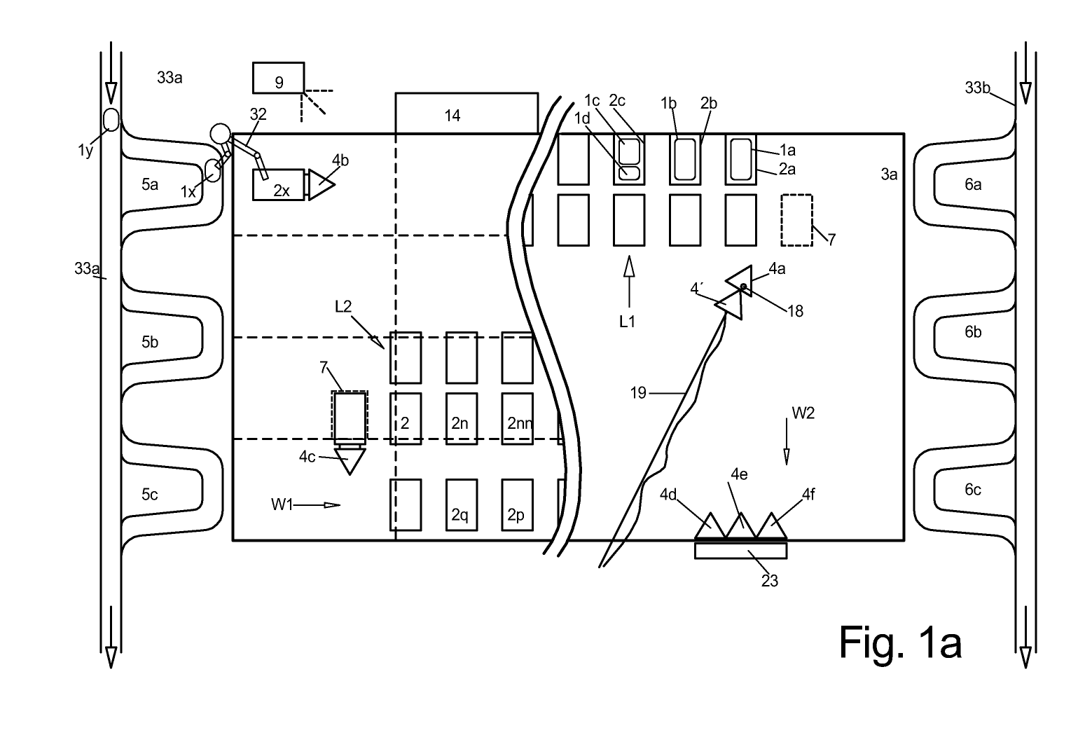

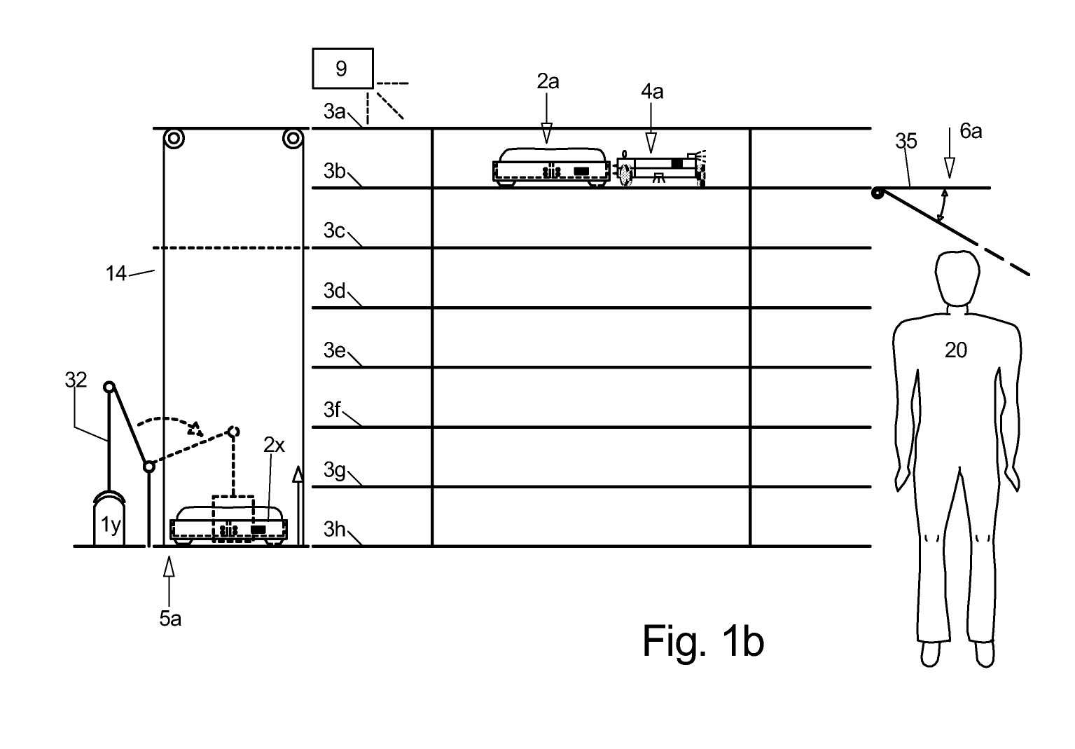

FIG. 1a illustrates a storage surface in top view;

FIG. 1b illustrates a storage surface with plural levels above one another in a lateral view;

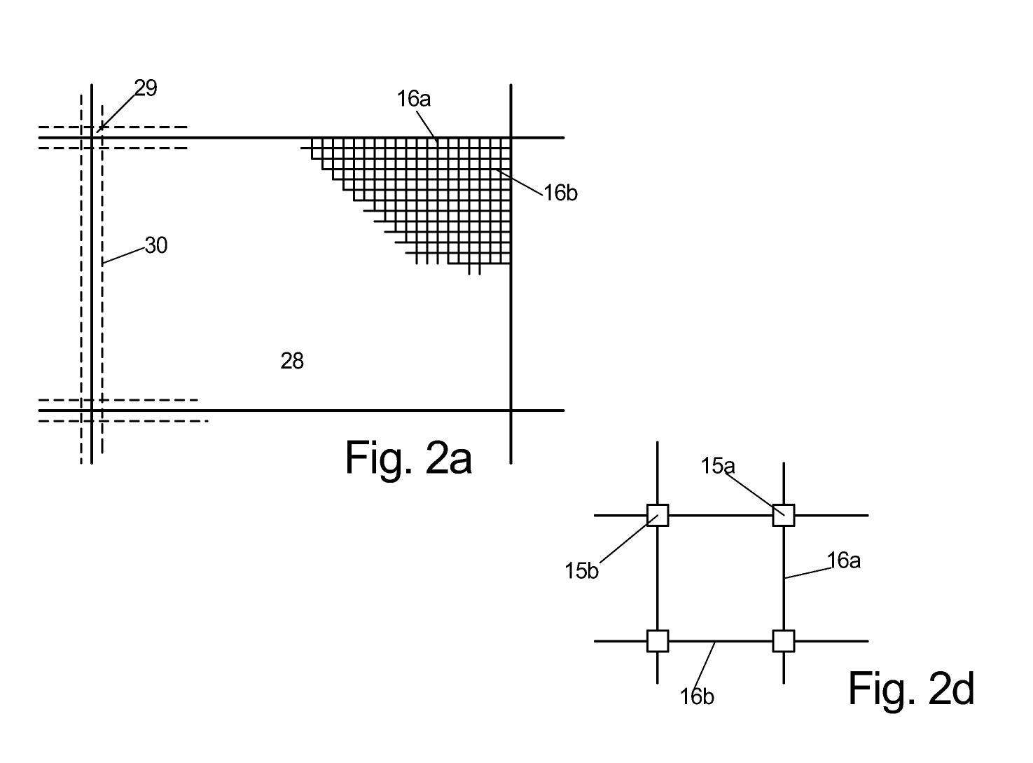

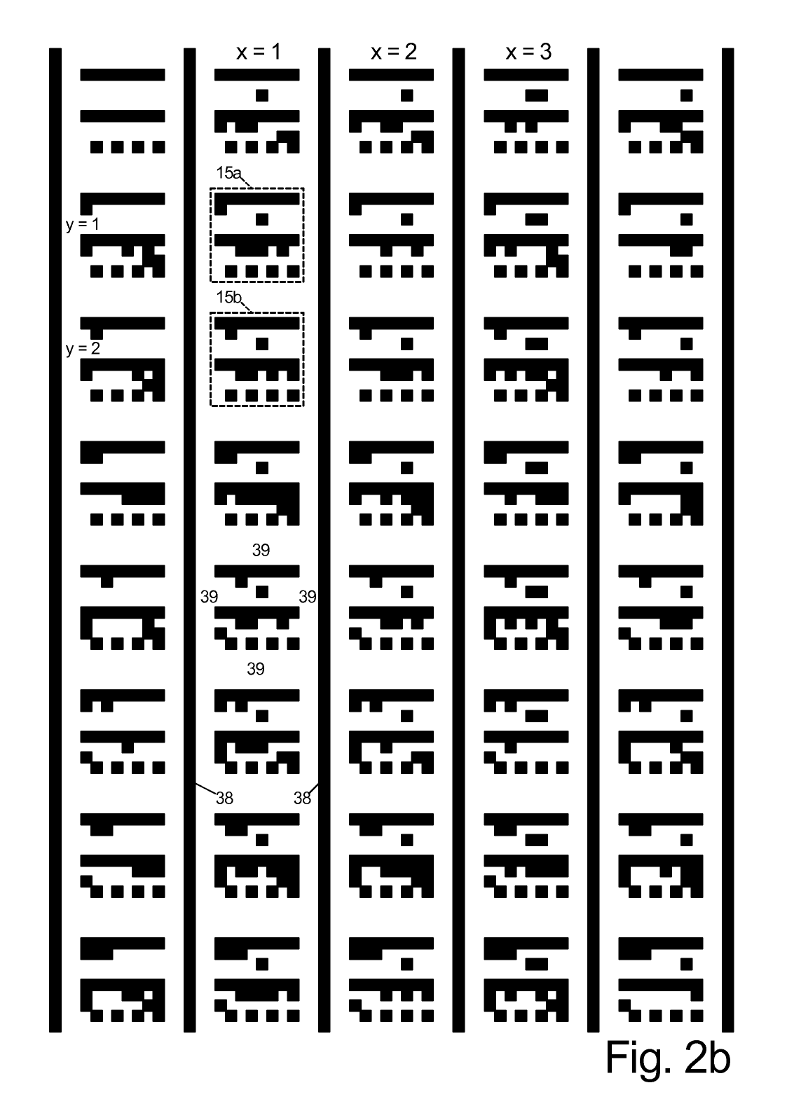

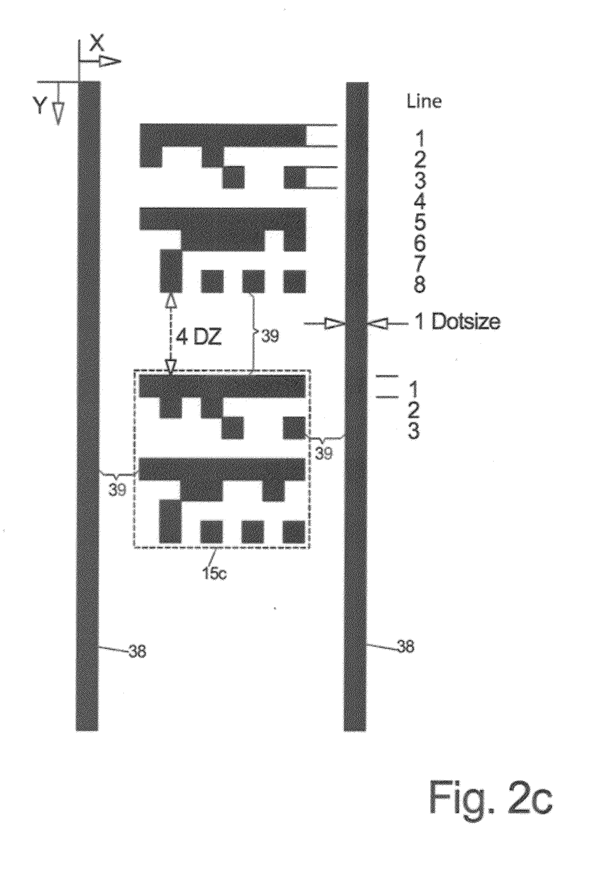

FIG. 2 illustrates enlarged details of a storage surface;

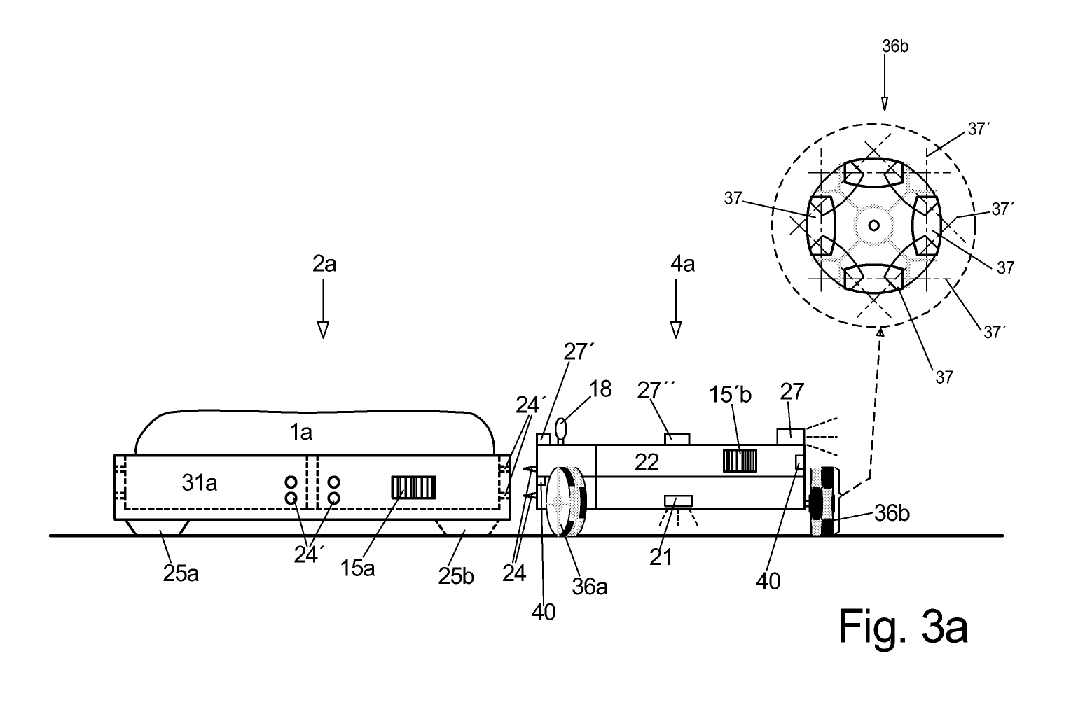

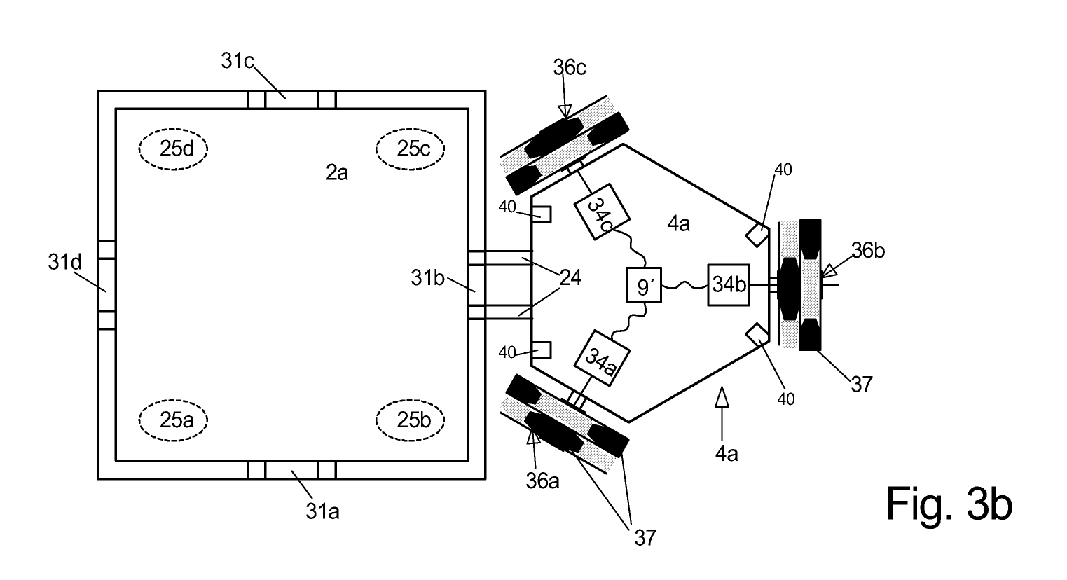

FIG. 3 illustrates the tractor and the trailer in a lateral view and in top view;

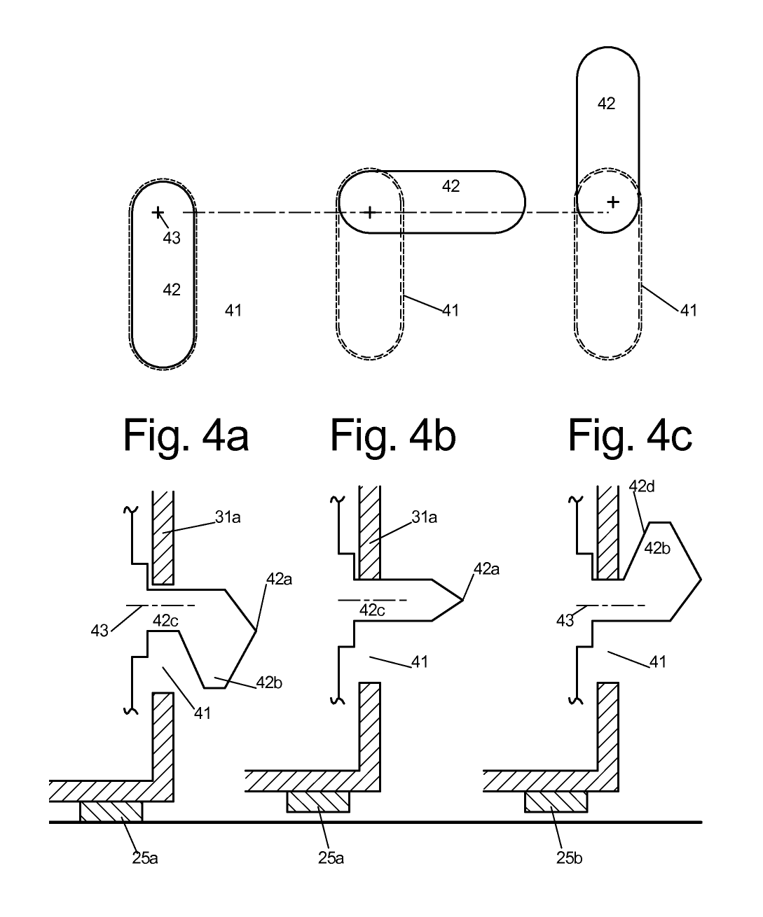

FIG. 4 illustrates a configuration of a coupling; and

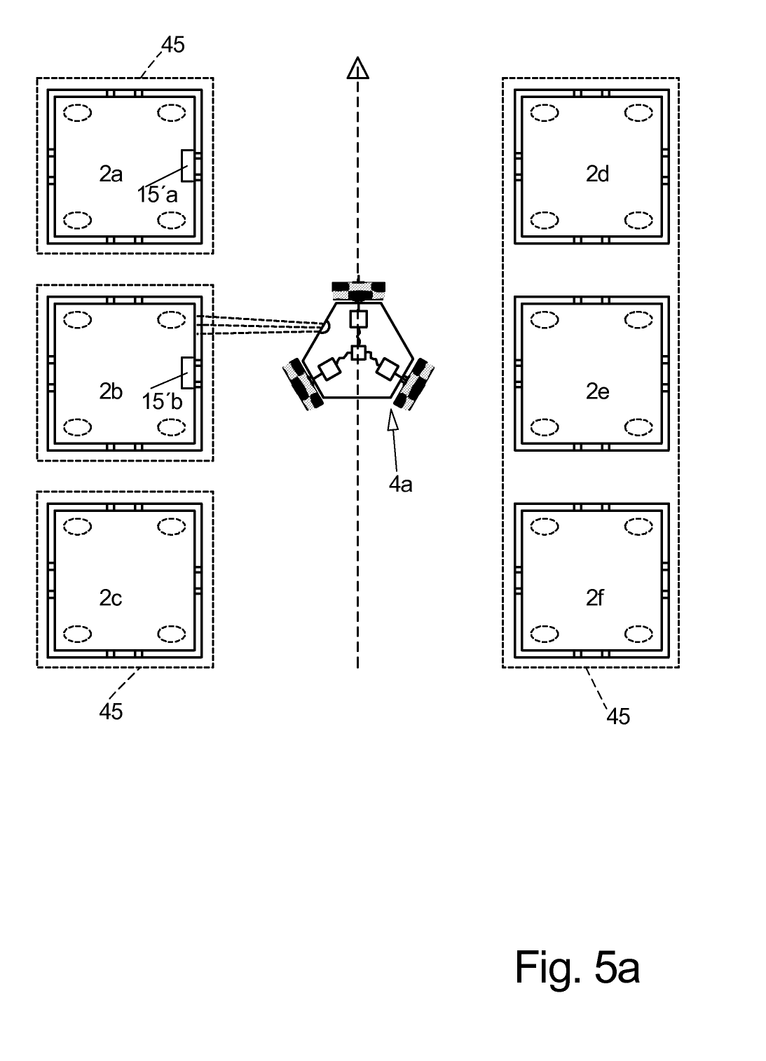

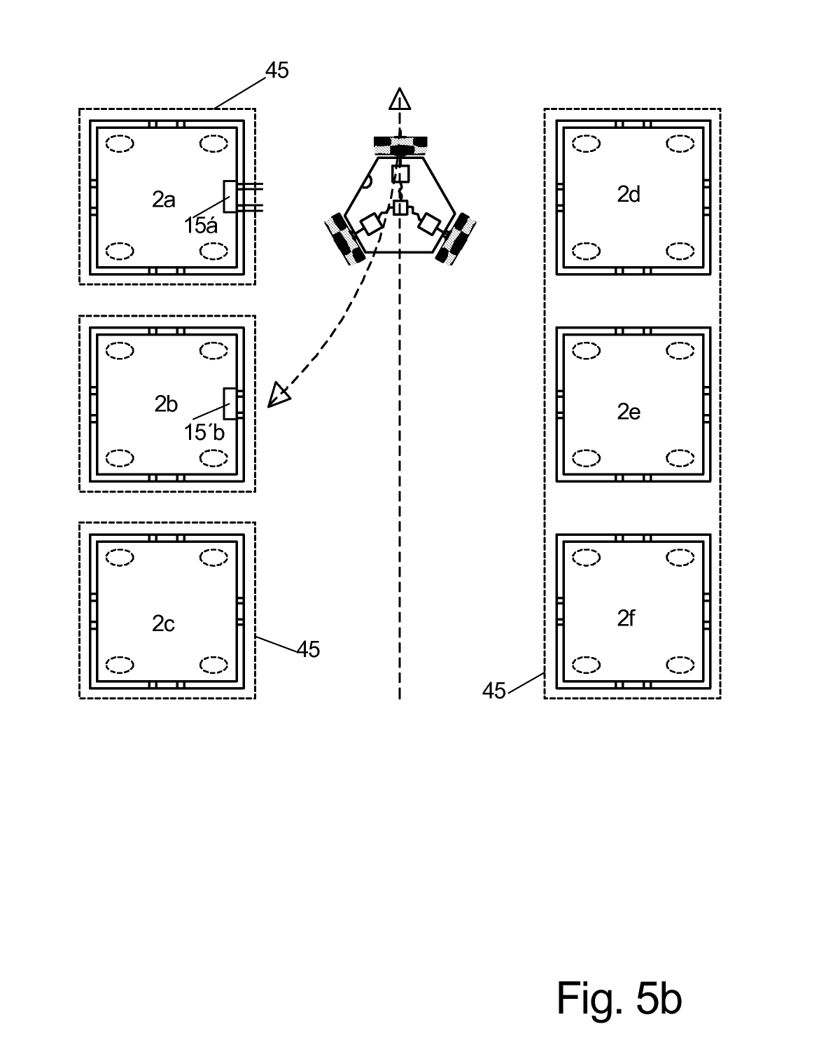

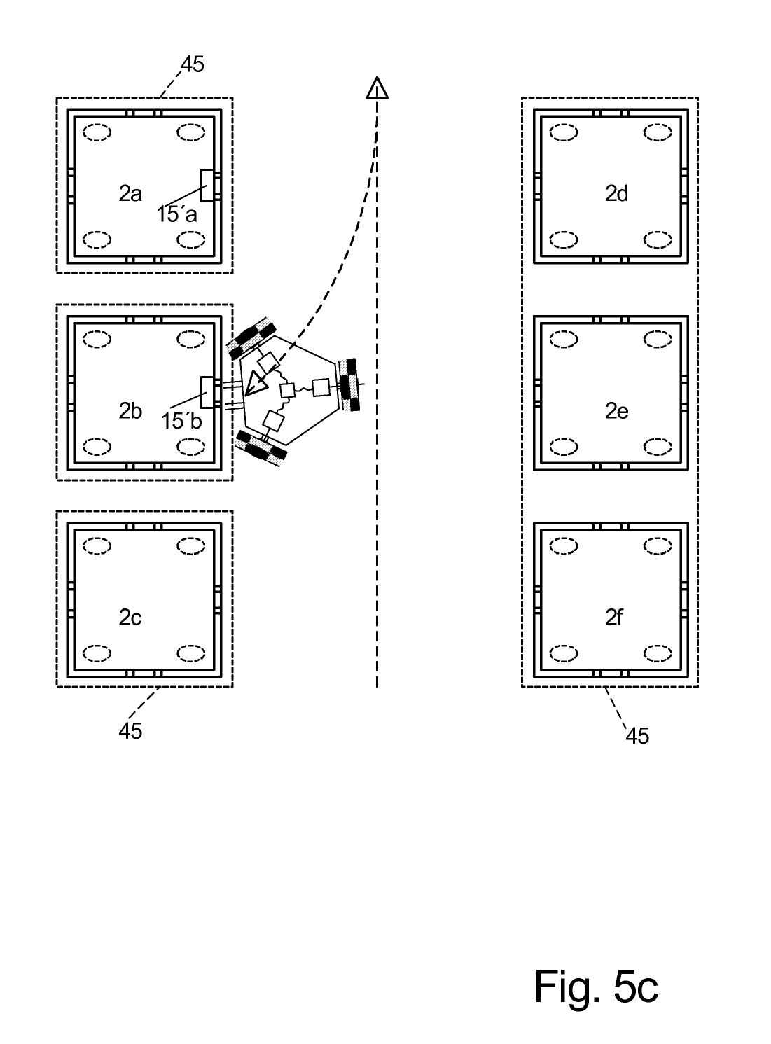

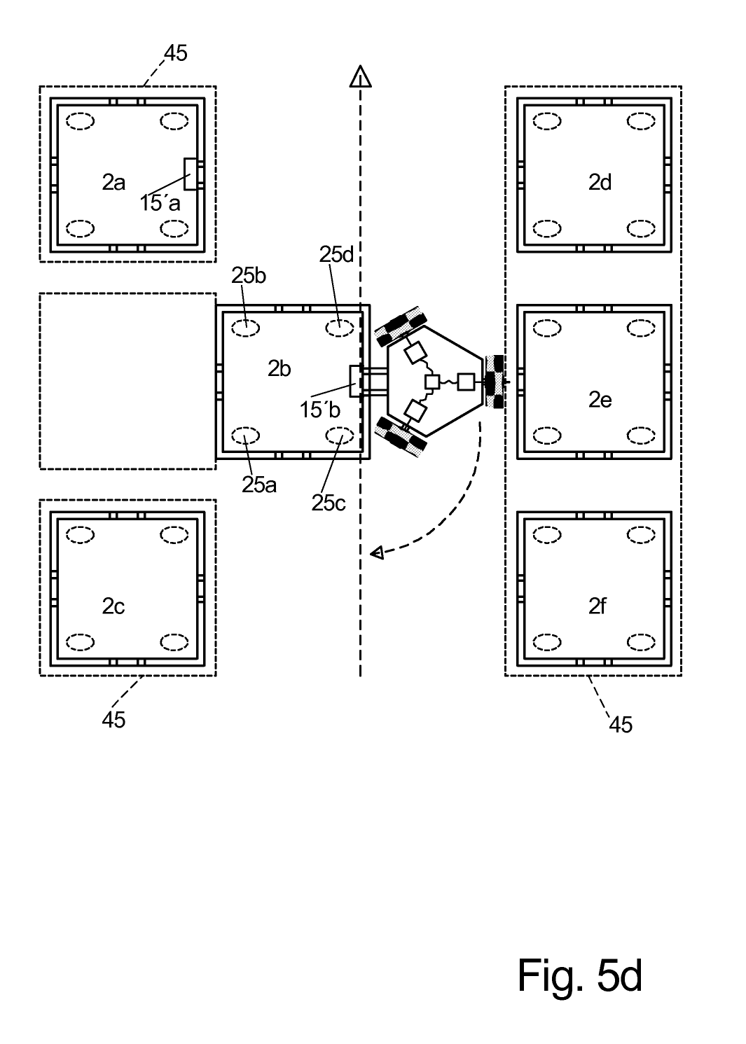

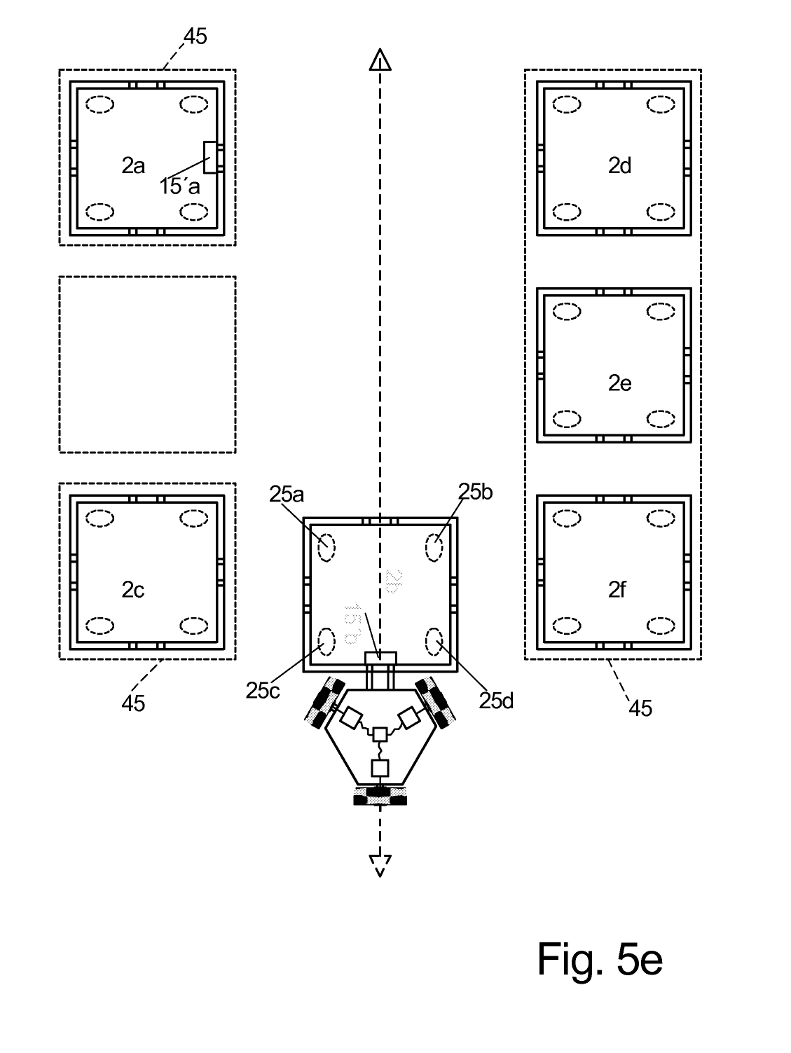

FIG. 5 illustrates a movement out of a parking spot.

FIG. 1a illustrates a top view of the storage surface 3a which is in this case rectangular but which is not a prerequisite of the invention. On the storage surface 3a, trailers 2a . . . loaded with products 1a . . . are parked and thus stored until they are needed elsewhere.

For this purpose there is one or plural loading stations 5a, b, c at one narrow side of the storage surface 3a where products 1x, 1y can be delivered to the loading stations and can be loaded through a load switching device provided at this location, preferably automatically e.g. through a robot 32 onto a trailer 2x provided there.

By the same token there are three unloading stations 6a-c in this case on the opposite face in which products can be analogously retrieved from loaded trailers provided at the unloading stations.

Delivering the products to the loading stations 5 and retrieving the products from the unloading stations 6 in this case is respectively performed through a conveyor belt 33a, b, wherein preferably at particular loading and unloading stations 5a . . . , 6a . . . an extraction of the products from the pass through conveyor belt is performed so that the product 1y stands still for transferring at the loading station 5a or the unloading station 5b and can be identified and gripped by the robot 32 which is typically done by suction cups instead of mechanical grippers.

The core idea of the invention is that the trailers 2a . . . do not have a drive but are being moved on the storage surface 3a through motor driven tractors 4a, b . . . but are resting in a self hemming manner in parked condition on the storage surface 3a that is precisely horizontal in an ideal case.

The tractors 4a, b . . . respectively move the trailers 2a, b preferably between a loading station e.g. 5a and one of the storage positions L1, L2 and also between a storage position L1 and L2 and an unloading station 6a, . . . . Also additional processing stations can be provided at which the products 1a, . . . disposed on the trailers 2a are provided e.g. with labels or processed in a different manner.

For this purpose the loading surface 3a should be clear of obstacles, thus also clear of struts or similar in order to impede a movability of the tractors 4a, b and trailer 2a, b . . . coupled to the tractors as little as possible.

FIG. 1a illustrates a storage position L2 in the left area of the figure, wherein the trailers 2m, 2n . . . are parked in double rows and wherein a movement path is open in each double row so that each of the trailers can be directly approached by a tractor, e.g. 4c, coupled and removed from its storage position 7.

Contrary thereto the storage position L1 in the right half of the figure is configured self blocking in that not all of the trailers 2b, 2c or each of the storage positions 7 are approachable directly, but are blocked by other trailers in front thereof, wherein the other trailers have to be removed first. A storage area of this type therefore is only useful when there are many identical products 1a, b on the trailers 2a, b so that no particular trailer is required to take product out of storage.

The left half of the figure illustrates another idling area W1 for unloaded trailers 2p, 2q . . . and the right half of the figure illustrates an idling area W2 for tractors 4d 4e, 4f that are presently not being used which are additionally automatically coupled to a charging station 23 at this idle position W2, wherein the charging station recharges the accumulator 22 in the particular tractors 4d, 4e during the idle time.

All movements of all moving elements, thus the movement paths and the movement times or movement time period 4a, b, the control of the conveyor belts 33a, b and in particular there product releases to the loading and unloading stations 5a . . . 6a . . . , the movements of the robots 32 and also the movements of an optionally provided elevator 14 which connects the storage areas 3a, 3b with one another that are arranged on top of one another of a multi floor storage are controlled by a central control 9, wherein the signal connection with the tractors 4a, b . . . is provided wirelessly since the tractors shall move independently from one another and freely on the storage surface 3a, b.

FIG. 1b illustrates a multi floor storage of this type with storage surfaces 3a, b arranged on top of one another in a lateral view. It is evident from the operator 20 illustrated adjacent thereto that the vertical distance of the storage surfaces 3a, b typically is too small for an operator 20 to get in there.

An elevator 14 is illustrated at the left face of the storage, wherein the elevator extends from the lowest to the highest storage surface 3h-3a and can stop at any level. When the elevator is in its lowest position, thus on the ground this is simultaneously the loading station 5a at which in turn a product e.g. 1y delivered from outside by a robot 32 is loaded onto an empty trailer 2x standing in the elevator. The loaded trailer is then automatically brought by the elevator 14 to the level provided by the central control 9 and at this location the loaded trailer is coupled through coupling a tractor that is approaching at this level and the trailer is moved out of the elevator 14 at this level to the storage position provided by the central control 9.

On the right side of FIG. 1b a tipping device 35 configured as a unloading station 6a is illustrated in a schematic manner, wherein the tipping device is configured to empty a loaded trailer that is placed thereon through tipping in that the product falls off the trailer onto a slanted slide or another feed element while the trailer remains on the tipping device 35 and can be brought back onto its storage surface.

FIG. 1b also illustrates that when storage surfaces 3a, b . . . are arranged on top of one another this immediately creates a problem of supporting these storage surfaces since starting with a particular surface extension of the storage surfaces 3a, b edge support only is not sufficient and supports have to be introduced in between with a spacing, wherein the supports act as obstacles for the trailers and tractor in the storage surfaces 3a, b . . . respectively arranged thereunder.

FIG. 2a illustrates a detail of a storage surfaces 3a in top view, wherein the storage surface can be assembled e.g. from a plurality of rectangular base plates 28 which are arranged in a grid pattern and can be supported by a support 29 in the corner points where four respective storage plates 28 join.

Between the supports additional trusses 30 can extend under the contact edges of two respective base plates 28. The particular base plates 28 are preferably sized large enough so that after removing the supports 29 and possibly the truss 30 in upward direction an opening is created which is large enough so that an operator 20 can at least reach through it preferably and can preferably also enter the multi level storage.

This is possible in that the supports 29 are respectively arranged on top of one another in the particular levels and after taking out the upper most base plate 28 the base plate arranged there under can also be disengaged and can be taken out through the opening arranged there above by tilting it vertical in the diagonal of the opening.

In the right upper corner of the base plate 28 furthermore a uniform system of longitudinal and transversal grid lines 16a, b is visible which is an option for the tractors, in practical applications these optical markers cover the entire surface of all base plates 28 and thus of the entire storage surface 3a, b . . . to find the predetermined path through sensors responding to these markings, since on these storage surfaces 3a, b the tractors 4a, b are not guided by rails or other form locking or friction locking elements, but are freely moveable according to the movement path predetermined by the central control.

In order to recognize in which field of the grid the tractor is disposed preferably bar codes 15a, b are provided in uniform distances, preferably in each field or at each field formed by the grid lines 16a, b.

FIG. 2b an in an enlarged detail FIG. 2c shows a solution in which each of the fields is essentially completely filled by such bar code 15a, b so that the respective sensor storage of a tractor 4a, . . . driving over the bar code can detect from the change from one bar code to another bar code where the tractor is located and in which direction it is moving.

For this purpose particular rectangular, in this case square two dimensional bar codes are arranged in columns below one another and separated from one another through guided lines 38 extending in column direction there between.

Each bar code includes a specific arrangement of black and white squares, the so called dots, in the present case 8 per line and 8 per column in each bar code.

The guidelines 38 have a width corresponding to the width of a dot and the particular bar codes 15a, b are laterally offset from the guidelines 38 through an empty space 39 corresponding to the width of two dots and the bar codes 15a, b are offset from one another in vertical direction through an empty space 39 with a width of four dots.

Through a sequence of black and white dots within a bar code 15a the desired information is encoded as usual wherein in this case the top view the fifth and eighth line of each bar code is not used for information transfer but only for position detection in that these lines look the same in all bar codes namely e.g. the first and fifth line are continuously black and in the eighth line only the second, fourth, sixth and eighth dots are black and the other dots arranged there between are white.

This way the remaining five lines with 8 bit each can be used to generate a code with 40 bit which is e.g. divided into regular 24 bit for encoding and an additional 16 bit CRC code for additional safety.

Thus, the bar codes 15a are smaller originally than illustrated in FIG. 2b and the camera 27 of the tractor which scans the bar codes thus has a detection surface so that it always has at least one entire bar code, preferably 1.5 to 2.0 bar codes in its view.

Due to the configuration of the bar codes always being the same and the guidelines 38 being continuous in one direction the tractor control 9′ through the camera 27 detects at least one bar code 15a . . . and thus based on the information encrypted therein at which location of a base plate 28 it is disposed.

For this purpose the particular base plates 28 are preferably identically imprinted and thus on the one hand side easily replaceable and producible with the same print manuscript so that the same bar code 15a . . . is always arranged on each base plate 28 on the same spot.

The information on which of the base plates 28, thus in which portion within the surfaces 3a the tractor is arranged then must come from another information source, in particular through simple counting the base plates in longitudinal direction and floor direction through the tractor control 9′,

As soon as the tractor control 9′ has recognized the bar code arranged for the time being in the view of the camera 27 and has processed it with respect to position and information content the tractor control 9′ knows the rotation position of the tractor 4a, e.g. with respect to the guidelines 38 by less than 1° and also the position, e.g. the distance of the camera 27 from the center of the bar code 15a . . . by less than 1 mm.

Since the particular bar codes 15a . . . on one base plate 28 respectively differ from one another with respect to their information content, thus no two identical bar codes 15a, b are provided on a base plate 28, the tractor control 9′ when detecting the bar code can drive the tractor 4a in the sub millimeter range exactly in the desired direction and to the desired position in that it continuously analyzes the bar codes arranged in view of the camera 27 of the tractor 4a and the tractor control changes the driving direction and the driving velocity of the tractor as a function thereof.

Since the tractor control 9′ not only keeps the last analyzed bar code 15a but also the next bar code e.g. 15 b that has completely moved into the viewing area of the cameral 27 in its memory in a preliminary manner, not only the current position but also the current driving direction is known when the tractor 4a . . . moves.

FIG. 2d illustrates another solution where the intersection points of the grid lines 16a, b, have been left open and wherein a bar code 15a, b is respectively provided in the intersection portions.

The FIGS. 3a and 3b in lateral view and in top view respectively illustrate a train including a tractor 4a and a trailer 2a.

In FIG. 3a both are separated from one another and the trailer 2a is loaded with a product 1a, in top view of FIG. 3b both are coupled with one another and permanently connected for reasons of clarity, however, the trailer 2a is illustrated unloaded.

As illustrated in top view of FIG. 3b the tractor is approximately triangular with a bar code reader 21 oriented against the base surface and three wheels 36a, b, c arranged in a triangle with identical sides, wherein the axes of the tractor 4a geometrically intersect in the center of the tractor, wherein the wheels are respectively drivable by a separate motor 38a-c and are controlled by the control 9′ which is provided in each tractor either with respect to rotation about its own axis or with respect to driving in a particular direction.

This is possible in that transversal sliding rollers are arranged in a running surface in each of the wheels 36a, b, c so that their rotation axis 37′ is arranged parallel to a tangential direction of the wheel 36a . . . viewed in axis direction and a convex circumferential surface of the transversal sliding rollers 37 forms the contact surface of the wheel 36a relative to ground.

The transversal sliding rollers 37 can thus be arranged in two circles axially offset from one another and circumferentially offset from one another on these wheels 36a in order to improve traction.

A tractor of this type is not only extremely maneuverable but can turn in place and can start in any desired direction from a stand still without having to rotate at all.

Accordingly each tractor 4a . . . has coupling elements 24 preferably not only on one lateral surface, but on all three of its lateral surfaces, thus in top view preferably respectively two coupling elements 24 arranged at a distance in each lateral surface. With these coupling element 24, the tractor 4a as evident from FIG. 3a can approach a trailer 2a . . . and can automatically and independently hook up the trailer and later when the trailer 2a is in the desired storage position it can also unhook the trailer again.

For this purpose the tractor 4a at its coupling side has two distance sensors 40 preferably also offset in transversal direction, preferably analog distance sensors which are preferably offset from one another further than the coupling elements 24 in order to determine a slight angular offset between tractor 4a and trailer 2a when approaching the trailer 2a based on different measured distances and to be able to compensate the angular offset before coupling through respective control of the motors 34a, b, c of the tractor 4a.

Furthermore the tractor 4a . . . as illustrated in FIG. 3 a includes a forward looking camera 27 and/or additionally a second camera 27a′ looking in opposite direction, thus the reverse direction and/or additionally also laterally viewing side view cameras 27″ and/or distance sensors, in particular all directions which are used during subsequent driving and in particular during moving in and out of parking spots to automatically control in an optical manner that no adjacent e.g. parked trailer or another obstacle like a strut of the storage surface is being touched.

An embodiment for a coupling is illustrated in FIG. 4.

On the side of the trailer 2a the coupling element is a coupling hole 41 configured as a longitudinal hole which is e.g. is arranged in a vertical direction.

On the side of the tractor 4a the coupling element is a coupling pinion 42 which horizontally protrudes beyond the front face of the trailer 4a and which is pivotable about a horizontal pivot axis 43 by e.g. 180°.

Thus, the coupling pinion 42 includes a locking lug 42b at its free end, which locking lug protrudes radially from the pivot axis 43 in one direction.

When the locking lug in the coupling position of FIG. 4a is oriented downward from the pivot axis 43 the coupling pin 42b can reach through the coupling hole 41, wherein a slight lateral offset from one another through a centering point 42a configured at the free front face of the coupling pin 42 facilitates self centering.

As soon as docking at the trailer 2a is completed, thus the side wall 31a . . . of the trailer 2a contacts the longitudinal stop 44 which is configured at the tractor 4a about the rear portion of the shaft of the coupling pinion 42, or the side wall is approximated close enough which is measured by the distance sensors 40 of the tractor 4a, the coupling pinion 42 is pivoted about the pivot axis 43.

Since the pivot axis 43 is eccentrically arranged in the shaft of the coupling pin 42 which is thus configured as a lift excenter 42, the pivoting has the effect that the top side of the shaft of the coupling pin 42 rises and presses the upper edge of the coupling hole 41 in upward direction and thus lifts the trailer 2a at the coupling end off the ground which is already the case when the interlocking lug 42 protrudes horizontally.

Through rotating the interlocking lug 42b forward the side wall of the trailer 2a is reliably pulled against the stop 44 through gravity through the existing slanted surface 42d on the back side of the interlocking lug 42b which causes an axial interlocking of the trailer 2a at the tractor 4a.

Since the storage surface 3a is flat and self hemming of the trailer 2a on the storage surface is sufficient no additional safety measures are required for this purpose. In order to obtain sufficient self hemming the trailers 2a preferably do not run on the ground through wheels, but only through sliding elements, thus four sliding surfaces 25a, b, c, d arranged in a rectangle under the base surface of the trailer 2a.

These sliding surfaces can be made from low friction plastic material, but also from a very much softer material compared to the top side of the running surface, like e.g. felt or another textile material which simultaneously prevents a scratching of the surface of the storage surfaces 3a through dust or other contaminations in that the storage surfaces are simultaneously being cleaned by the sliding surfaces 25a, b, c, d, made e.g. from textile material.

Also for the trailers 2a, b which according to the top view of FIG. 3b are preferably sized square, coupling elements 24′ for interaction with the coupling elements 24 of the tractors are arranged in each of the lateral surfaces 31a-d.

By the same token each trailer 2a and each tractor 4a at least on one of its lateral surfaces, better on all lateral surfaces has a bar code 15a′, 15b′ so that based on the bar code a trailer 2a, . . . or a tractor 4a, . . . can also be recognized through a camera 27 or 27″ or 27′ as provided on each tractor 4a and which preferably looks ahead horizontally and which can also be pivotably arranged in particular for verifying the storage coordinates provided by the central computer and for re-measuring slight movements that may have occurred through movements and/or collisions that may have occurred.

Thus a coupling- and moving out of a parking space maneuver can be performed as illustrated in FIG. 5.

The tractor 4b which shall hook up and pick up the parked trailer 2b moves along an alley used as a movement path 46 between two rows of trailers 2a-2f parked adjacent to one another wherein one of the trailers 2b parked in the alley needs to be picked up.

While the tractor 2b moves along the alley between the rows of trailer 2a . . . used as movement path 46 the tractor with its lateral camera 27′ looks for the correct trailer is 2b in that its scans the bar codes 15′a, 15′b arranged on the coupling sides of the trailers, wherein the tractor knows from the floor markings in which area the desired trailer 2b has to be located.

As soon as the tractor has detected the correct trailer 2b this way the tractor moves along the movement path (FIG. 5b) so that it approaches the coupling side of the trailer 2b (FIG. 5c) with the coupling side of the tractor through subsequent backward driving and pivoting.

Thus the tractor uses ground navigation for coarse approach and uses approximation sensors 40 provided at its coupling side shortly before docking in order to detect and compensate an angular offset between tractor 4b and trailer 2b.

Furthermore it determines the precise position of the trailer 2b with its reversing camera 27′ in case this should be necessary at all in view of a possible centering area which is already provided by the coupling 24 or by separate centering devices.

After coupling as described in FIG. 4 the tractor 4b together with the coupled trailer 2b initially drives straight ahead out of the storage position 7 of the trailer 2b (FIG. 5d) and then performs an approximately arch shaped movement with the tractor 4b about the rear end of the trailer 2b until the entire train is oriented in longitudinal direction of the movement path 46 again (FIG. 5e).

Thus, however the actual pivot point of the train during this arch shaped path is not precisely known since it depends from the friction conditions below the rear sliding surfaces 24 a, b of the trailer 2b, thus e.g. the center of gravity can be in the center of the sliding surface 25a or the center of the sliding surface 25b or a point there between.

Since, however, the tractor 4b and trailer the 2b form a rigid train and their positions relative to one another after coupling are precisely known, an ongoing checking of the actual rotation position and position of the tractor with reference to floor markings suffices for the tractor control 9′ to be able to compute and correct the respective position of the entire train.

Since the tractor control 9′ together with the command to pick up the trailer 2b has also received information regarding the entire storage map along the entire movement path, thus the positions of all obstacles like e.g. of the other trailers 2a, 2c through 2f including a tolerance zone 45 computed as a precautionary measure by the central control 9 about the actual position of these obstacles wherein the tolerance zone must not be touched by the train either, collisions are largely excluded.

The cameras 27, 27′ provided at the tractor 4a are additionally typically only used when collisions with other objects are eminent, e.g. according to the distance sensors and hand control is then being used.

Should an eminent or actual collision with an obstacle still occur, the position of the obstacle is reported to the central computer 9 which then either performs an enlargement of the tolerance zone 25 of the obstacle or a re-measuring of the position of the obstacle.

In the same manner parking a trailer 2b coupled to the tractor 4b in a parking spot can be performed in an inverse analog manner.

Thus during insertion of the trailer 2b the end of the trailer 2b opposite to the tractor 4b due to the changing friction conditions is slid over laterally more or less than planned and when a collision with an adjacent obstacle is to be expected, the tractor control 9′ causes the train to move forward and schedules another parking attempt in which the initially experienced lateral movement of the trailer is already considered.

In case moving into a parking spot is not successful for a predetermined number of attempts the tractor control 9′ requests an alternate new parking position from the central computer 9, wherein after the central computer 9 records the non implementable parking position as difficult and possibly removes it completely from the list of parking positions to choose from until e.g. in this portion the distances between the storage positions can be increased.

A large portion of the weight of the relatively heavy tractors 4a which have to provide sufficient traction on the floor to pull at least one fully loaded trailer 2a typically is the weight of the accumulator 22 which can be frequently recharged at the charging station 23.

FIG. 3a furthermore illustrates a recue eyelet 18 which is provided at each tractor 4a . . . and/or also at each trailer at which e.g. a particular service tractor which on the one hand side performs cleaning tasks and on the other hand side also performs a removal of broken down tractors 4a, . . . from the storage surface can hook up, wherein the rescue eyelet as illustrated supra can protrude in upward direction, possibly also in the center of the tractor or how the coupling can be arranged in the lateral surface.

This is illustrated in the right figure half of FIG. 1.

Therein the tractor 4a which e.g. has not reacted anymore after parking and uncoupling the trailer parked above thereof is moved out of the storage surface 3a in a direction towards the lower image border or pulled out by a service tractor 4′ which can be a normal tractor or a specially configured service tractor 4′ which has already coupled to the rescue eyelet 18 of the crashed tractor 4a and can be moved out through its own drive and through a pullback cable 19 leading outside of the storage surface 3a and can be moved or pulled out by an operator 20 through vision through its at least one camera which can provide more pull force than through the traction and the drive of the service tractor 4′ by itself.

Since the reason for a tractor to break down may also be a problem of wireless transmission of the signals from the central control in a particular portion of the storage surface which would then also happen to a service tractor 4′ that is controlled wirelessly, can in this case be provided to the service tractor through a signal cable 26 which runs from the service tractor 4′ to the outside of the storage surface 3a and which can be provided with signals through the wired decentralized control 9 or a manual control of the operator 20.

### REFERENCE NUMERALS AND DESIGNATIONS

1a . . . product
2a, b . . . trailer
3a . . . storage surface
4a . . . tractor
4′ service tractor
5 loading station
6 unloading station
7 storage position
8 parking position
9 central control
9′ tractor control
12a drive path
13 idle position
14 elevator
15a, b . . . bar code marking
15′a . . . bar code
16a, . . . grid line system
17 cleaning tractor
17′ cleaning trailer
18 rescue eyelet
19 pull back cable
20 operator
21 bar code reader
22 accumulator
23 charging station
24, 24′ coupling
25a, b sliding surfaces
26 signal cable
27 camera
28 base plate
29 support
30 truss
31a, b side wall
32 robot
33 a, b conveyor belt
34a, b, c motor
35 tipping device
36a, b, c wheel
37 transversal sliding roller
37′ rotation axis
38 guide line
39 empty space
40 distance sensor
41 coupling hole
42 coupling pinion
42a centering point
42b interlocking lug
42c lift excenter
42d slanted surface
43 pivot axis
44 longitudinal stop
45 tolerance zone
46 movement path
L1 storage position
W1 idling position

1. (canceled)

2. The method according to claim 15, wherein for storage
a tractor (4a, . . . ) approaches at least one empty trailer (2a, b . . . ) which is arranged in a parking position (8), couples the trailer independently, and
moves the trailer to a loading station (5)
where the trailer (2a, b . . . ) is loaded with at least one product (1a, . . . ),
subsequently the tractor (4a, . . . ) moves the trailer (2a, b, . . . ) to a storage position (7), parks the trailer (2a, b, . . . ) at the storage position,
decouples the trailer (2a, b . . . ) and parks it, and
the tractor (4a, . . . ) optionally moves into an idle position (13), and
for retrieving products (1a, . . . )
the tractor (4a, . . . ) approaches at least one loaded trailer (2a, b . . . ) standing in a storage position (7) or in a processing position, couples it independently, and
moves it to an unloading station (6),
where the product (1a, . . . ) is retrieved from the trailer (2a, b . . . ), and
e.g. the empty trailer (2a, b . . . ) is moved by the tractor (4a, . . . ) to a parking position (8) and uncoupled and parked at this location, and
the tractor (4a, . . . ) is optionally moved to an idle position (13).

3. The method according to claim 15, wherein
the method also includes moving at least the trailer (2a, b, . . . ) in particular together with the tractor (4a, . . . ) into another level of the storage surface (3a, . . . ), in particular through an elevator (14) and/or
the tractors (4a, . . . ) are connected with the central control (9) wirelessly, in particular through WLAN and as an emergency channel through radio or ultrasound and obtain from the central computer besides the start- and target position of their movement path also at least data regarding the storage map and the movement path to be used and the destination and optionally the speed of the movement.

4. The method according to claim 15,
the tractors (4a, . . . ) are steerable and moveable in all direction from a standstill and in particular configured to rotate on a spot and/or;
the tractors (4a, . . . ) find their drive path exactly through markings that are scanned touch free in particular optically or electrically scanned on the storage surface (3a, . . . ) in particular bar code markings (15a, b . . . ) or markings distributed in a random manner and/or
the markings include a particularly rectangular grid line system (16a, . . . ) and additionally include markings for defining particular grids like e.g. bar codes (15′a, . . . ) are arranged in an interior of the grid or in intersection areas of the grid.

5. The method according to claim 15,
wherein specially configured cleaning tractors (17) are used for cleaning the storage surface (3a, . . . ) or specially configured cleaning trailers (17′) are moved by a tractor over the storage surface and/or
all trailers (2a, b . . . ) and tractors (4a, . . . ) include markings that are readable contactless, in particular bar codes (15′a . . . ) and respective sensors, in particular bar code readers (21) are provided at all processing stations.

6. The method according to claim 15, wherein
incase a tractor (4a, . . . ) fails the software of the tractor switches the tractor off and shuts it down and sends an emergency message to the central control (9) and/or;
in case a tractor (4a, . . . ) fails and goes out of control this is detected by the central control (9) and/or the tractor control (9′) due to a deviation from a predetermined tractor behavior and the tractor (4a, . . . ) is switched off and shut down by the central control (9) and the portion of the storage surface (3a . . . ) where the tractor that went out of control has caused disorder is blocked by the central control for further storage and retrieval in a preliminary manner.

7. The method according to claim 15, wherein
for removing a defective tractor (4a . . . ) a second tractor approaches the defective tractor, couples it and removes it from the storage, in particular through moving it to an unloading station (6) wherein removing the defective tractor is performed in particular through manual control of the operator and camera view of the second removing tractor and a special rescue eyelet at the tractors is used for coupling the defective tractor and in particular;
a pullback cable (19) is optionally attached at the rescue tractor, wherein the other end of the pull back cable is supported by an operator (20) outside of the storage surface (3a, . . . ) and the pull back cable is used for pulling back the defective tractor together with the rescue tractor.

8. A storage device for products (1a, . . . ) comprising:
a flat storage surface (3a, . . . ) which is physically interrupted through as few fixated obstacles as possible, and
on which or remote from which plural operating positions, in particular loading stations (5) and unloading stations (6) are predetermined,
on which trailers (2a, b . . . ) on which at least one respective product (1a . . . ) is placed can be moved and parked,
motor driven tractors (4a, . . . ) which couple and uncouple the trailers (2a, b . . . ) and can move them on the storage surface (3a, . . . ),
a navigation system so that the tractors (4a, . . . ) can operate on a predetermined movement path on the storage surface (3a, . . . ),
a central control (9) which controls the plural tractor (4a, . . . ) simultaneously operating on the storage surface (3a, . . . ) with respect to their movement paths and movement times.

9. The storage according to claim 8, wherein
the storage surface (3a, . . . ) extends over plural levels which are connected with one another through connecting devices, in particular elevators (14) in which the trailers (2a, b . . . ) are moveable by themselves or together with a tractor (4a, . . . ) from one level into another and/or;
an orientation of the tractors (4a, . . . ) on the storage surface (3a, . . . ) is provided through markings on the storage surface or on the ceiling surface there above which are scanable in a contactless manner, in particular markings or patterns that are applied uniformly or randomly, in particular bar codes (15′a . . . ) and the tractors include respective sensors, in particular at least one bar code reader (21) and/or
the uniformly applied markings on the storage surface (3a, . . . ) or the ceiling surface there above in particular include grid lines (16a, . . . ) extending perpendicular to one another or guidelines (38) extending parallel to one another and the particular markings, in particular bar codes (15a, . . . ) are arranged in an interior of the grids or at intersection points of the grids or between the guide lines (38),
the randomly provided markings or patterns are the darker fibers in a surface of wood particle boards which otherwise includes lighter colored fibers, wherein the particle boards are used as floor boards (28) or ceiling boards.

10. The storage according to claim 8,
wherein the tractors (4a, . . . ) are connected with the central control (9) wirelessly, in particular through WLAN and additionally through a wireless emergency channel in particular through radio or ultrasound, and/or
wherein the processing stations also include idle positions (13) for tractors (4a, . . . ) that are not being used and a charging station (23) for the energy storages in the tractors (4a, . . . ), in particular electrical accumulators (22) are provided at the idle positions and/or;
the trailers (2a, b) are configured so that they can be easily lifted through coupling at least in the portion of the coupling (24) and thus reduce their contact surface with the ground and the trailers in particular only have two wheels or sliding surfaces (25a, b) on a side oriented away from the coupling, wherein they rest on the ground with their wheels or sliding surfaces.

11. The storage according to claim 8,
wherein the trailers (2a, b . . . ) include coupling elements that are arranged in a defined manner in their side wall (31a, b) and in particular include coupling openings and the coupling (24, 24′) is arranged at least in two faces of the trailer (2a, . . . ) that are arranged opposite to one another, in particular in all lateral surfaces of the in particular rectangular trailer (2a, . . . ) and/or
wherein the coupling (24) includes two or more coupling elements offset in transversal direction which provide torque proof coupling of trailer (2a, . . . ) and tractor (4a, . . . ).

12. The storage according to claim 8,
wherein the tractor (4a, . . . ) includes an attachment device for a rescue cable and/or a rescue eyelet (8) for attaching another defective tractor and/or an attachment device for a signal cable (26), in particular a WLAN cable and/or
wherein the tractor (4a, . . . ) includes at least one camera (27) and the tractor is switchable from computer control to manual control.

13. The storage according to claim 8, wherein
the distances of the levels of the storage surfaces (3a . . . ) as a function of the product size to be stored and as a function of the dimensions of the tractors (4a, . . . ) and the trailers (2a, b) are selected as low as possible and in particular are smaller than would be sufficient for a human operator (20) to reach into and/or
for a storage surface (3a, . . . ) in plural levels above one another the storage surface (3a, . . . ) is assembled from grid shaped, in particular rectangular base plates (28) which are placed on uniformly arranged supports (29) or trusses (30) and which are liftable in upward direction and which are large enough so that a human operator (20) can climb up or down into the storage through the provided opening.

14. The storage according to claim 8,
wherein the trailers (2a, b . . . ) include a configuration of their loading surface or interior that is adapted to types of products stored (1a, . . . ) and the trailers (2a, . . . ) include in particular side walls (31a, b) extending from the base surface,
wherein the storage includes motor driven lifting tractors which are configured to engage at least one product directly through a gripping device, in particular pick it up directly from the ground and support it during a movement of the lifting tractor.

15. A method for storing products (1a . . . ) placed on at least one trailer (2a,b . . . ) which method comprises:
placing products (1a . . . ) on trailers (2a,b . . . );
moving said trailers through motor driven tractors (4a . . . );
coupling and uncoupling said tractors from said trailers for products;
moving said tractors back and forth on the storage surface (3a . . . ) between the loading stations (5) and unloading stations (6), storage positions (7) for loaded trailers (2a,b . . . ) or products (1a . . . ) and parking positions (8) for empty trailers on the drive path;
predetermining said drive path by a central control (9);
wherein the drive paths (12) and also the positions (5-8) are defined without form locking in particular at the storage surface (3a, . . . ) or for a multi level storage surface at the ceiling above the respective storage surface without form locking.
